(19) United States
(12) Patent Application Publication
(10) Pub. No.: US 2006/0134339 A1
(43) Pub. Date: Jun. 22, 2006

(54) Coating compositions and methods of making and using them

(76) Inventors: Shengxian Wang, Shanghai (CN); Donald Wayne Whisenhunt JR., Niskayuna, NY (US); Jun Xiao, Shanghai (CN); Chang Wei, Niskayuna, NY (US); Zhixin Zheng, Shanghai (CN); Yanrong Zhu, Shanghai (CN)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/019,447

(22) Filed: Dec. 21, 2004

(51) Int. Cl. B05D 1/12; B05D 7/00

(52) U.S. Cl. 427/407.1; 427/180

(57) ABSTRACT

A resin including a plurality of colloidal metal oxide particles; a silane, and a water dispersible polymer is disclosed. The silane includes an amino silane or uredosilane or both. A corrosion inhibitor is also disclosed. The corrosion inhibitor includes a conducting polymer or conducting oligomer with a conjugated structure that provides electric conductivity when doped; and an anion. The anion includes at least one anion selected from a group consisting of phosphomolybdate anion, permanganate anion, dichromate anion, ferrate anion, molybdate anion, salicylate anion, ethylenediamine tetraacetic anion, and amino acid anion. A coating composition including the resin and a corrosion inhibitor is disclosed. Also disclosed are methods of making the resin and the coating composition and method of treating a substrate with the coating composition.

### BACKGROUND OF THE INVENTION

The present invention generally relates to coating compositions and methods of treating a substrate with the coating composition. Particularly, the invention relates to coating compositions comprising a corrosion inhibitor and methods of treating a substrate with the coating compositions comprising a corrosion inhibitor.

### DESCRIPTION OF RELATED ART

Many substrates, such as metals, are susceptible to some form of corrosion, such as atmospheric corrosion including the formation of various types of rust. Corrosion of the surface of a substrate may significantly affect the quality of the substrates, as well as that of the products produced therefrom. Although corrosion may often be removed, removing corrosion is time consuming, costly, and may further diminish the integrity of the substrate.

Corrosion inhibitors are a known component in some coating compositions. However, a coating is a sophisticated system and adding corrosion inhibitors may adversely affect other coating properties beyond corrosion performance, such as adhesion, compatibility with resin technologies, thermal stability, and mechanical properties.

Some known coating compositions, such as primers, contain corrosion inhibitors that provide corrosion resistance to a substrate. A variety of methods are known for priming a substrate with a coating composition. However, as shown in FIG. 1, some known priming processes 10 require a pretreating Step 12 to prepare a substrate for a primer before the priming Step 14. Otherwise, the primer will not adhere to some substrates. Particularly, a metal substrate may not accept a primer, which is often an organic resin, without pretreating.

Thus, there remains a need for coating compositions which provide at least some of the above needs. Also needed is a method of making and using the coating composition.

### SUMMARY

The purpose and advantages of embodiments of the invention will be set forth and apparent from the description that follows, as well as will be learned by practice of the embodiments of the invention. Additional advantages will be realized and attained by the methods and systems particularly pointed out in the written description and claims hereof, as well as from the appended drawings.

An embodiment of the invention provides a resin. The resin comprises: colloidal metal oxide particles; a silane; and a water dispersible polymer. The silane comprises an amino silane or ureidosilane or both.

A second embodiment provides a method of making a resin. The method comprises: i) providing an aqueous dispersion of colloidal metal oxide particles and providing a silane comprising at least an amino silane or ureidosilane, wherein the silane at least partially functionalizes the plurality of colloidal metal oxide particles; and ii) providing a water dispersible polymer to the aqueous dispersion, wherein the at least partially functionalized colloidal metal oxide particles are at least partially incorporated within the water dispersible polymer to form the resin.

A third embodiment provides a corrosion inhibitor. The corrosion inhibitor comprises a conducting polymer or conducting oligomer with a conjugated structure that provides electric conductivity when doped; and an anion. The anion comprises at least one anion selected from a group consisting of phosphomolybdate anion, permanganate anion, dichromate anion, ferrate anion, molybdate anion, salicylate anion, ethylenediamine tetraacetic anion, and amino acid anion.

A fourth embodiment provides a coating composition comprising a resin and a corrosion inhibitor. The resin comprises: colloidal metal oxide particles; a silane; and a water dispersible polymer. The silane comprises an amino silane or ureidosilane or both.

A fifth embodiment provides a method of making a coating composition comprising a resin and a corrosion inhibitor. The method comprises: i) providing an aqueous dispersion of colloidal metal oxide particles and providing a silane comprising at least an amino silane or ureidosilane, wherein the silane at least partially functionalizes the colloidal metal oxide particles; ii) providing a water dispersible polymer to the aqueous dispersion comprising the at least partially functionalized colloidal metal oxide particles, wherein the at least partially functionalized colloidal metal oxide particles are at least partially incorporated within the water dispersible polymer; and iii) providing a corrosion inhibitor to the aqueous dispersion comprising the at least partially functionalized colloidal metal oxide particles.

A sixth embodiment provides a method of treating a substrate comprising: applying a coating composition to a substrate. The coating composition comprises a resin and a corrosion inhibitor. The resin comprises: colloidal metal oxide particles; a silane; and a water dispersible polymer. The silane comprises an amino silane or ureidosilane or both.

A seventh embodiment provides a coating composition. The coating composition comprises a resin and a corrosion inhibitor at least partially within the resin. The resin comprises: colloidal metal oxide particles; a silane; and a water dispersible polymer. The silane comprises an amino silane or ureidosilane or both. The corrosion inhibitor comprises: a conducting polymer or conducting oligomer with a conjugated structure that provides electric conductivity when doped; and an anion. The anion comprises at least one anion selected from a group consisting of phosphomolybdate anion, permanganate anion, dichromate anion, ferrate anion, molybdate anion, salicylate anion, ethylenediamine tetraacetic anion, and amino acid anion.

The accompanying figures, which are incorporated in and constitute part of this specification, are included to illustrate and provide a further understanding of the method and system of the invention. Together with the description, the drawings serve to explain the principles of the invention.

### BRIEF DESCRIPTION OF THE DRAWINGS

FIG. 1 is a schematic representation of the known steps of a priming process;

FIG. 2 is a schematic representation of a resin in accordance with an embodiment of the invention;

FIG. 2a is an enlarged schematic representation of a portion of the resin;

FIG. 3 is a schematic representation of a method of making a resin in accordance with an embodiment of the invention;

FIG. 4 is a flow chart of a method of making a resin in accordance with an embodiment of the invention

FIG. 5 is a schematic representation of a coating composition comprising a corrosion inhibitor and resin in accordance with an embodiment of the invention;

FIG. 6 is a schematic representation of a coating composition comprising a corrosion inhibitor and resin in accordance with an embodiment of the invention; and

FIG. 7 is a flow chart of a method of making a coating composition in accordance with an embodiment of the invention.

### DETAILED DESCRIPTION OF EXEMPLARY EMBODIMENTS

Reference will now be made in detail to exemplary embodiments of the invention, which are illustrated in the accompanying figures and examples. Referring to the drawings in general, it will be understood that the illustrations are for the purpose of describing a particular embodiment of the invention and are not intended to limit the invention thereto.

Whenever a particular embodiment of the invention is said to comprise or consist of at least one element of a group and combinations thereof, it is understood that the embodiment may comprise or consist of any of the elements of the group, either individually or in combination with any of the other elements of that group. Furthermore, when any variable occurs more than one time in any constituent or in formula, its definition on each occurrence is independent of its definition at every other occurrence. Also, combinations of substituents and/or variables are permissible only if such combinations result in stable compounds.

With reference to FIG. 2, there is shown one embodiment of a resin 100. The resin 100 is water dispersible or water soluble. The resin 100 comprises colloidal metal oxide particles 112; one or more silanes 114; and one or more water dispersible polymers 116. The silane 114 comprises an amino silane or ureidosilane or both.

In one embodiment, colloidal metal oxides particles 112 either individually comprise at least one of SiO₂, TiO₂, ZnO, CeO₂ or in any combination thereof. In a particular embodiment, the colloidal metal oxides particles 112 comprise SiO₂.

In yet another embodiment, colloidal metal oxides particles 112 comprise CeO_{2.} Improved corrosion resistance performance might be expected with CeO₂ because CeO₂ may function both as a corrosion inhibitor and a reinforcing filler for the coating.

In one embodiment, the silane 114 comprises an amino silane. In a particular embodiment, the amino silane either individually comprises at least one of 3-aminopropyltriethoxysilane, 3-aminopropyltrimethoxysilane, 4-aminobutyltriethoxysilane, 4-amino-2-(dimethylethoxysilyl)propane, N-(2-aminoethyl)-3-aminoisobutyldimethylmethoxysilane, N-(2-aminoethyl)-3-aminoisobutylmethyldimethoxysilane, (aminoethylaminomethyl)phenethyltrimethoxysilane, N-(2-aminoethyl)-3-aminopropylmethyldimethoxysilane, N-(2-aminoethyl)-3-aminopropyltriethoxysilane, N-(2-aminoethyl)-3-aminopropyltrimethoxysilane, N-(6-aminohexyl)aminomethyltrimethoxysilane, N-(6-aminohexyl)aminopropyltrimethoxysilane, N-(2-aminoethyl)-11-aminoundecyltrimethoxysilane, 3-(m-aminophenoxy)propyltrimethoxysilane, m-aminophenyltrimethoxysilane, p-aminophenyltrimethoxysilane, aminophenyltrimethoxysilane, N-3-[(amino(polypropylenoxy)]aminopropyltrimethoxysilane, 3-aminopropyldiisopropylethoxysilane, 3-aminopropylmethylbis(trimethylsiloxy)silane, 3-aminopropyldimethylethoxysilane, 3-aminopropylmethyldiethoxysilane, aminopropylsilanetriol, 3-aminopropyltrimethylsilane, 3-aminopropyltris(methoxyethoxyethoxy)silane, 3-aminopropyltris(trimethylsiloxy)silane, and 11-aminoundecyltriethoxysilane or in any combination thereof. In a particular embodiment, the amino silane comprises 3-aminopropyltriethoxysilane.

In another embodiment, the silane 114 comprises an ureidosilane. Examples of ureidosilanes include, but are not limited to, ureidopropyltriethoxysilane and ureidopropyltrimethoxysilane.

In one embodiment, the silane 114 comprises a plurality of silanes 114, as in FIG. 2. The plurality of silanes 114 may either individually include amino or ureidosilane or in any combination thereof.

In one embodiment, the water dispersible polymer 116 either individually comprises at least one epoxy latex, polyurethane latex, polyacyrlate latex, and silicone latex, or any combination thereof. In a particular embodiment, the water dispersible polymer 116 comprises an epoxy latex. In another embodiment, the water dispersible polymer 116 comprises a plurality of water dispersible polymers 116. The plurality of water dispersible polymers 116 may include any combination of the above listed water dispersible polymers 116 described hereinabove.

In the resin 100, the amount or percentage of silane 114, colloidal metal oxide particles 112, and water dispersible polymers 116 may readily be adjusted to provide resins 100 of different qualities, such as resins 100 with corrosion resistance. Furthermore, how the amount of silane 114, colloidal metal oxide particles 112, and water dispersible polymers 116 are allocated may also vary. In one embodiment in terms of ratios, the ratio of amine 114 to colloidal metal oxides 112 is in a range from 1 to 10 and the ratio of amine 114 to water dispersible polymers 116 is in a range from 1 to 5. In another embodiment in terms of percentage, the silane 114 is in a range from about 1% to about 60%, the colloidal metal oxide particles 112 are in range from about 1% to about 40%, and the water dispersible polymer 116 is in a range from about 1% to about 60%.

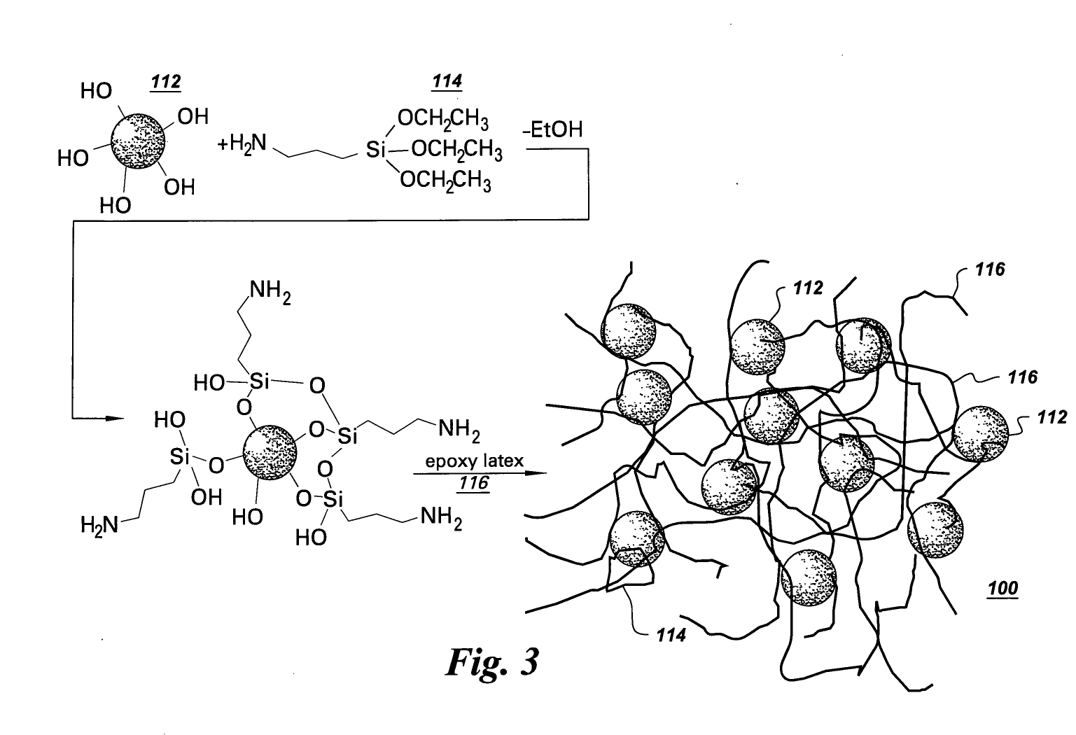

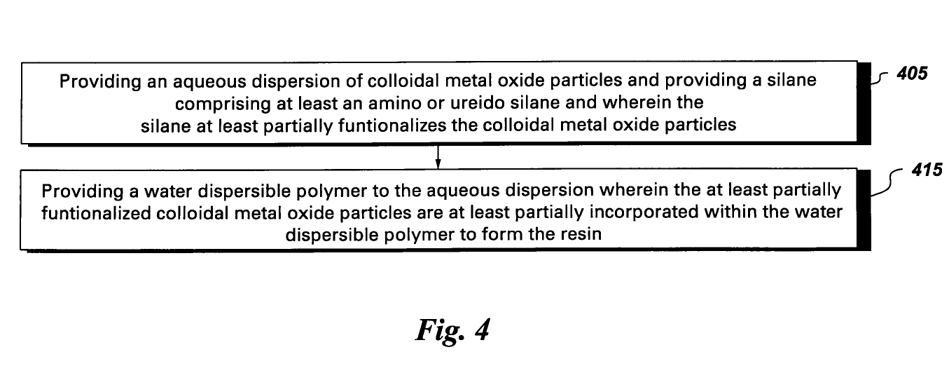

With reference to FIG. 3 and FIG. 4, next will be described a method of making the resin 100. FIG. 3 is a schematic representation of a method of making the resin 100. FIG. 4 is a flow chart of a method of making the resin 100. The method comprises, at Step 405, providing an aqueous dispersion of colloidal metal oxide particles 112 and providing one or more silanes 114. The method is not limited by when the colloidal metal oxide particles 112 and silane 114 are provided. The silane 114 may be added before, after, or simultaneously with the colloidal metal oxide particles 112. The silane 114 at least partially functionalizes the colloidal metal oxide particles 112. For illustration only and not to be limited by the mechanism, the silane 114 may functionalize the colloidal metal oxide particles 112 as shown in FIG. 2a.

It is within the scope of the invention to adjust the method of making the resin 100 to suit various needs, such as varying the average size of colloidal metal oxide particles 112. The average size of the colloidal metal oxide particles 112 may be controlled by various factors. For example, the average size of colloidal metal oxide particles 112 is sensitive to acid, base, and salt. The average size of colloidal metal oxide particles 112 may be increased by adding an amount of acid. In one embodiment, the average size of the colloidal metal oxide particles 112 increased from 20 nm to 80 nm after adding acetic acid. The average size of the colloidal metal oxide particles 112 was measured by a light scattering particle size analyzer.

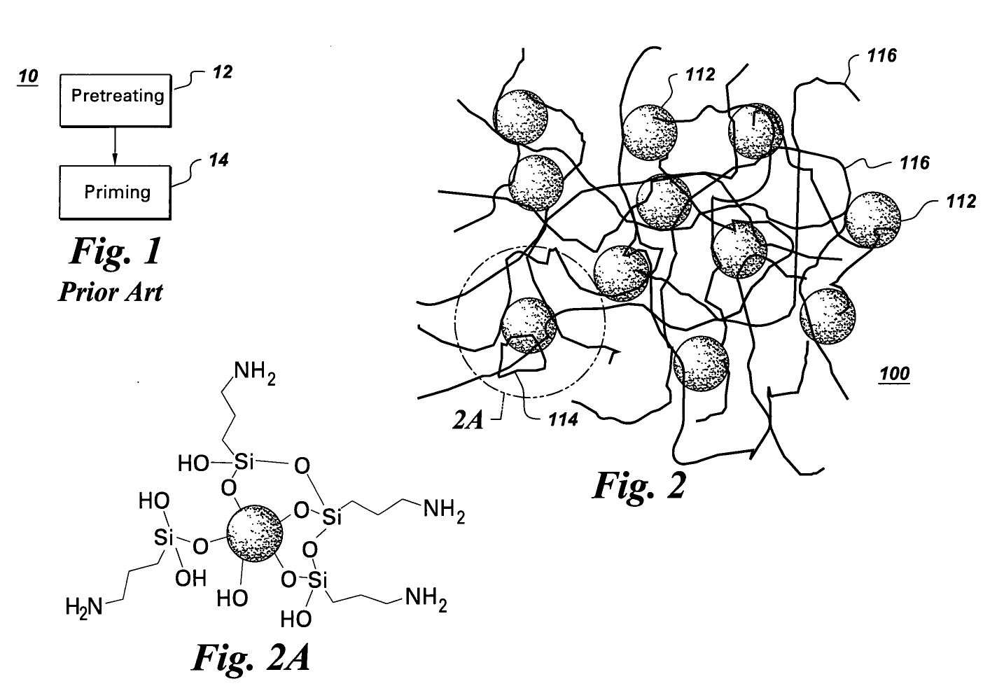

At Step 415, one or more water dispersible polymers 116 are provided to the aqueous dispersion. The at least partially functionalized colloidal metal oxide particles are at least partially incorporated within the water dispersible polymer to form the resin 100. In one embodiment, the colloidal metal oxide particles 112 are homogeneously dispersed within the water dispersible polymers 116 as shown in FIG. 1 and FIG. 3. In another embodiment, the colloidal metal oxide particles 112 are randomly dispersed within the water dispersible polymers 116.

Although the resin 100 itself may provide a certain degree of corrosion resistance, incorporation of a corrosion inhibitor may provide additional corrosion resistance. Consequently, another embodiment of the invention provides a corrosion inhibitor 200. The corrosion inhibitor 200 comprises one or more conducting polymers or one or more conducting oligomers 212 with a conjugated structure that provides electric conductivity when doped; and one or more anions 214. The anion 214 comprises at least one anion selected from a group consisting of phosphomolybdate anion, permanganate anion, dichromate anion, ferrate anion, molybdate anion, salicylate anion, ethylenediamine tetraacetic anion, and amino acid anion.

In one embodiment, the corrosion inhibitor 200 includes a conducting polymer 212. The conducting polymer 212 either individually comprises at least one of polyaniline, polypyrrole, polythiophene and their derivatives or in any combination thereof. In another embodiment, the corrosion inhibitor 200 comprises at least one conducting oligomer 212. In one embodiment, the conducting polymer or oligomer 212 comprises a plurality of conducting polymers or oligomers 212 while in another embodiment, the anion 214 comprises a plurality of anions. In one embodiment of the corrosion inhibitor 200 in terms of percentage, the conducting polymer or oligomer 212 is in a range from about 1% to about 99%, and the anion 214 is in a range from about 1% to about 60%.

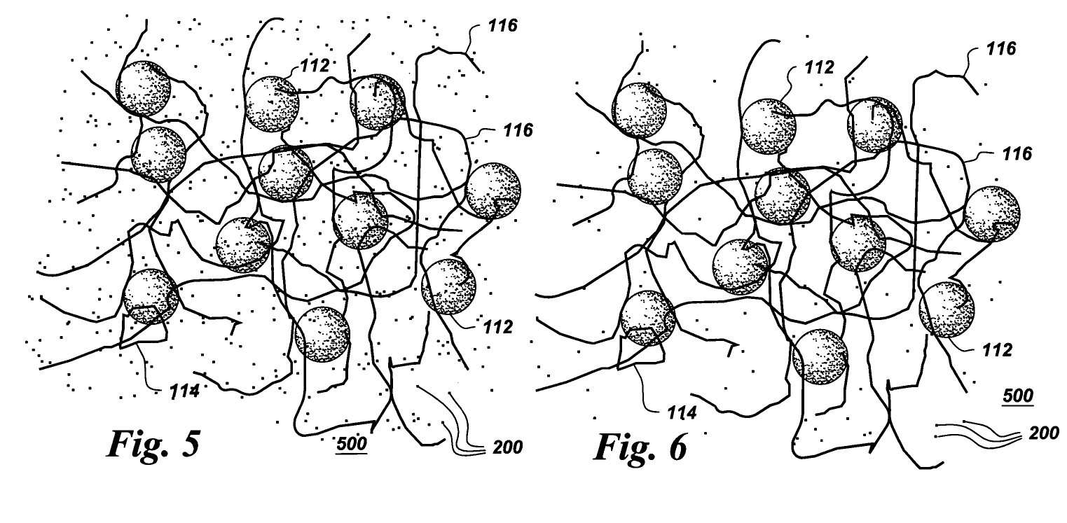

With reference to FIG. 5-6, next will be described an embodiment of a coating composition 500 comprising one or more resins 100 as previously described hereinabove and one or more corrosion inhibitors 200 as previously described hereinabove.

The coating composition 500 may readily vary as to the amount or percentage of corrosion inhibitor 200 and as to the amount or percentage of the resin 100. Furthermore, the coating composition 500 may readily vary as to how the amount of corrosion inhibitor 200 and resin 100 are allocated within the coating composition 500, as in FIGS. 5-6. FIG. 5 is a schematic representation of the coating composition 500 comprising a corrosion inhibitor 200 and resin 100 wherein the corrosion inhibitor 200 is homogeneously dispersed or allocated within the coating composition 500. FIG. 6 is another schematic representation of the coating composition 500 wherein the amount of corrosion inhibitor 200 is less compared to FIG. 5 and not as evenly distributed within the coating composition 500. In one embodiment in terms of percentage, the corrosion inhibitor 200 is in a range from about 1% to about 60%, and the resin 100 is in a range from about 1% to about 99%.

The coating composition 500 may further comprise other materials, such as fillers and additives such as thickeners, and wetting or dispersing agents. Examples of fillers include layered silicate clays, such as montmorillonite clay, and other type of clays, such as fumed silica and mica etc. The type and amount of fillers may be adjusted to achieve coating compositions 500 with desired properties. For example, montmorillonite clay may be added to improve the barrier properties of the coating composition 500. Layered silicate clays, such as smectite clays, may be added to improve barrier property.

The pH of the coating composition 500 may range from 4 to 10. The pH of coating composition 500 may also be adjusted to achieve desired properties. The fillers and additives may be compatible within a certain range of pH.

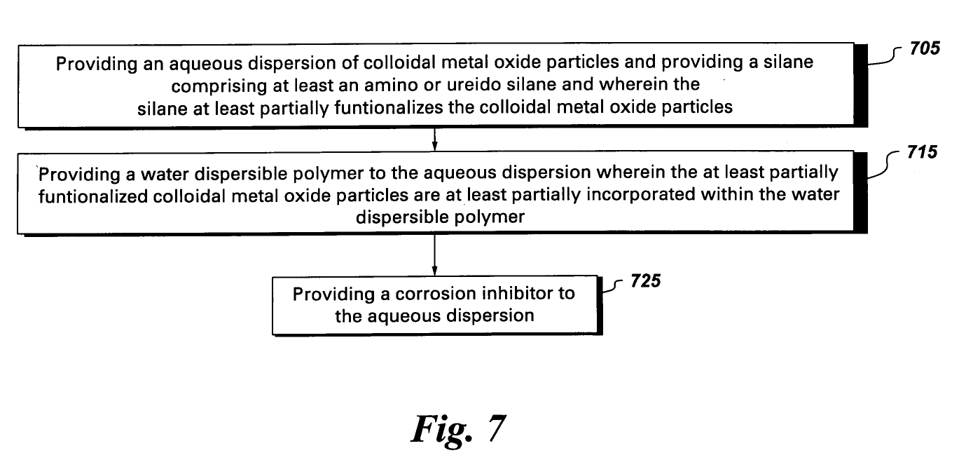

With reference to FIG. 7, next will be described a method of making a coating composition 500. FIG. 7 is a flow chart of a method of making a coating composition 500.

The method comprises, at Step 705, providing an aqueous dispersion of colloidal metal oxide particles 112 and providing a silane 114. The silane 114 comprises at least an amino silane or ureidosilane and at least partially functionalizes the colloidal metal oxide particles 112. The method is not limited by when the silane 114 is added. The silane 114 may be added before, after, or simultaneously with the colloidal metal oxide particles 112. At Step 715, a water dispersible polymer 116 is provided to the aqueous dispersion. The at least partially functionalized colloidal metal oxide particles 112 are at least partially incorporated within the water dispersible polymer 116. At Step 725, a corrosion inhibitor 200 is provided to the aqueous dispersion. In one embodiment, the corrosion inhibitor 200 comprises a conducting polymer or conducting oligomer 212 with a conjugated structure 200 that provides electric conductivity when doped; and an anion 214. The method is not limited by when the corrosion inhibiter 200 is provided. The corrosion inhibiter 200 may be added before, after, or simultaneously with the water dispersible polymer 116.

Optionally, the corrosion inhibitor 200 may be milled or grinded to better incorporate the corrosion inhibitor 200 in the coating composition 500. The method is not limited by when the corrosion inhibitor 200 is milled. In one embodiment, the corrosion inhibitor 200 is milled before providing the corrosion inhibitor 200 to the aqueous solution. In another embodiment, the corrosion inhibitor 200 is provided to the aqueous solution and then the aqueous solution with the corrosion inhibitor 200 is milled.

The coating composition 500 may have various applications, such as inhibiting or minimizing corrosion. Consequently, another embodiment of the invention provides a method of treating a substrate comprising applying a coating composition 500 to a substrate. The coating composition 500 comprises one or more resins 100 and one or more corrosion inhibitors 200 as previously described hereinabove.

Examples of substrates include, but are not limited to, metal, wood, plastic, concrete, and combinations thereof. In one embodiment, the substrate comprises a metal substrate.

In one embodiment, treating the substrate with the coating composition 500 combines a pre-treatment step, which prepares a substrate to accept the primer, and priming step into a single step.

A typical way of treating or applying the coating composition 500 on to metal substrates is by dipcoating, brushing or spraying the metal substrate with the coating composition 500.

In one example, dipcoating is performed at a speed of 65 mm/min. After about 24 hours at room temperature, the coating is cured at 130° C. for 30 min. Parameters such as dipcoating speed, time left at room temperature before curing, curing temperature and curing time of the coating may have an effect on the performance of the coating composition 500 and may readily be adjusted and is within the scope of the invention.

The following 5 examples of resins 100 and coating compositions 500 are summarized in Table 1.

TABLE 1

| | | Col- | | Water | Corro- | |
|---|---|---|---|---|---|---|
| | | loidal | | dispers- | sion | |
| | | metal | | ible | Inhi- | |
| | Subject of | oxide | Silane | polymer | bitors | Creepage |
| | Example | 112 | 114 | 116 | 200 | Rating |
| Exam- | Resin 100 | Silica | Amino | Epoxy | — | 9 (96 hr) |
| ple 1 | | | silane | latex | | |
| Exam- | Resin 100 | Silica | Amino | Epoxy | — | 9 (216 hr) |
| ple 2 | | | silane | latex | | |
| | | | and | | | |
| | | | ureido | | | |
| | | | silane | | | |
| Exam- | Corrosion | — | — | — | PMo- | |
| ple 3 | inhibitor | | | | PAn | |
| | 200 | | | | | |
| Exam- | Coating | Silica | Amino | Epoxy | PMo- | 9 (96 hr) |
| ple 4 | composition | | silane | latex | PAn | |
| | 500 | | | | | |
| Exam- | Coating | Silica | Amino | Epoxy | PMo- | 9 (96 hr) |
| ple 5 | composition | | silane | latex | PAn | |
| | 500 | | | | and | |
| | | | | | ZnO | |

### EXAMPLE 1

Example 1 describes a process of forming a resin 100 and coating a substrate with the resin 100. The resin 100 includes colloidal silica as the colloidal metal oxide 112, 3-aminopropyltriethoxysilane (APTES) as the silane 114, and epoxy latex as the water dispersible polymer 116.

A 14.7 g amount of colloidal silica (silica content: 34 wt. %) was first diluted with 182.7 g water. Then a mixture of 24 g silane (APTES), 72 g ethanol and 6.6 g acetic acid was slowly added to the diluted silica colloidal metal oxide to form a mixture and stirred overnight. Then, 20 g of epoxy latex (solid content: 50%, epoxy equivalent: 440-450 g/equiv. epoxy) was added to the mixture to form the resin 100. After stirring for 30 minutes, the surface of a substrate was dip-coated with the resin 100. In this example, a cleaned cold-rolled steel panel was the substrate. A wet film was formed on the steel substrate. The wet film was dried at ambient temperature overnight; then cured at 130° C. for 30 minutes. After the steel panel was cooled down to room temperature, the steel panel was spray coated with a commercial available polyester based paint as topcoat and cured at 180° C. for 15 minutes.

Anti-corrosion performance was tested according to ASTM B117 (Standard Practice for Operating Salt Spray (Fog) Apparatus) and ASTM D1654 (Standard Test Method for Evaluation of Painted or Coated Specimens Subjected to Corrosive Environments). The coated steel panels were cross-scribed, and then put into the salt spray chamber for neutral spray salt testing. Anti-corrosion performance was evaluated by the value of creepage along the scribe.

After 96 hours exposure in a salt fog, the rating of the resin 100 coating on the steel panel was 9 (the creepage was less than 0.5 mm), while the rating of a topcoat only without the resin 100 on the steel panel was 5 (the creepage was 5 mm).

### EXAMPLE 2

Example 2 describes a process of forming a resin 100 comprising multiple kinds of silanes 114, as compared to Example 1 which had one type of silane 114, and coating a substrate with the resin 100.

The procedure was the same as described in Example 1, except the resin 100 includes the amino silanes APTES as well as ureidosilanes A1524 (3-ureidopropyltrimethoxysilane, UPTMS).

A 2.4 g amount of APTES, 7.2 g ureidosilane, 28.8 g ethanol, and 2.64 g acetic acid was added slowly to a diluted colloidal silica (5.88 g 34 wt. % silica colloidal metal oxide diluted by 73.08 g water) to form a mixture. The mixture was then stirred overnight. Then, 8 g of epoxy latex (solid content: 50%, epoxy equivalent: 440-450 g/equiv. epoxy) was added to the mixture to form the resin 100. The resin 100 was then stirred for about 30 minutes.

The surface of a substrate was coated with the resin 100 as in Example 1 and the evaluation method of anti-corrosion performance was the same as described in the Example 1.

A 96 hours test showed that the resin 100 comprising ureidosilane APTES had almost the same anti-corrosion performance as the resin 100 in Example 1 without ureidosilane. However, a 216-hour test showed the resin 100 with ureidosilane had better anti-corrosion performance than that without ureidosilane, as in Example 1. After 216 hours salt spray test, the rating for the resin 100 coating with ureidosilane was 9 (creepage was less than 0.5 mm), and the rating for the resin 100 coating without ureidosilane was 7 (creepage was about 2 mm).

### EXAMPLE 3

Example 3 describes a process of making the corrosion inhibitors 200. A 50 g amount of aniline was dissolved in 500 mL 1 mol/L HCl solution and cooled to about 5° C. in ice bath. 122 g ammonium peroxydisulfate (NH₄)₂S₂O₈ was dissolved in 500 mL 1 mol/L HCl solution and then dropped to the aniline solution to form a mixture. After about 5 minutes, the mixture became dark green as a precipitate formed. The mixture was stirred overnight. Then the dark green precipitate was filtered to form a cake. The cake was washed portionwise with 1 mol/L HCl solution until the filtrate became colorless. Then the dark green precipitate cake was suspended in a 500 mL 0.1 mol/L NH₄OH solution, and stirred overnight. The suspension was then filtered and washed three times with 0.1 mol/L NH₄OH. Then the filtered cake was resuspended in 0.1 mol/L NH₄OH solution for 2 hours. The filtered cake then became black in color. Then the black cake was collected and washed with 0.1 mol/L NH₄OH.

A 20 g amount of the black filtered cake was then doped with the anion phosphormolybdic acid (H₃PMo₁₂O₄₀). The filtered cake was doped by suspending in phosphormolybdic acid solution (50 g H₃PMo₁₂O₄₀ in 500 mL deionized water) to form a mixture. The mixture was stirred overnight, then filtered, washed by deionized water until the filtrate became clear. The filtered cake was dried at room temperature and then dried at 60° C. overnight under vacuum.

### EXAMPLE 4

Example 4 describes a method of making a coating composition 500 comprising the resin 100 and corrosion inhibitors 200 and coating a substrate with the coating composition 500. The corrosion inhibitor 200 comprises phosphomolybdic acid doped polyaniline (PMo-PAn), wherein the conductive polymer 212 comprises polyaniline, and anion 214 comprises phosphomolybdate anion.

A 14.7 g amount of silica colloidal metal oxide (silica content: 34 wt %) was diluted with 182.7 g water. Then, a mixture of 24 g aminopropyltriethoxysilane, 72 g ethanol and 6.6 g acetic acid was added slowly to the diluted silica colloidal metal oxide to form a 300 g mixture. The mixture was stirred overnight.

A amount of 9.3 g ground or milled corrosion inhibitor PMo-PAn and 0.5 g wetting/dispersing agent were added to the 300 g mixture above. After mechanical stirring for 5 min, the mixture comprising the corrosion inhibitor was ground. The grinding time was 5 hours at 2000 rpm. The grinding formed particles with an average particle size of 2 μm. The average particle size was measured by a light scattering particle size analyzer.

Then, 20 g of epoxy latex ((solid content: 50%, epoxy equivalent: 440-450 g/equiv. epoxy) was added to the ground mixture and mechanically stirred for 30 minutes to form a coating composition 500.

The surface of a substrate was coated with the coating composition 500. The coating composition 500 was applied as in Example 1 and the evaluation method of anti-corrosion performance was the same as described in the Example 1.

After 96 hours salt spray test, the rating of the coating composition 500 was 9 (creepage was about 0.1 mm).

This coating composition 500 with the resin 100 and corrosion inhibitor PMo-PAn demonstrated better anti-corrosion performance than just the resin 100 without the corrosion inhibitor 200 as in Example 1.

### EXAMPLE 5

Example 5 describes a method of making coating composition 500 comprising the resin 100 and a combination of the corrosion inhibitors 200, PMo-PAn and ZnO.

The procedure was the same as described in Example 4 except 9.3 g PMo-PAn was replaced by 6 g PMo-PAn and 3 g ZnO in the mixture. In the dried film, the content of corrosion inhibitor 200, PMo-PAn was 13.4% and corrosion inhibitor 200 ZnO was 7.1%.

After 96 hours salt spray test, rating of the coating composition 500 was 9 (creepage was about 0.1 mm).

This coating composition 500 with the resin 100 and combination of corrosion inhibitors 200 demonstrated better anti-corrosion performance than just the resin 100 without the corrosion inhibitor 200 as in Example 1

While the invention has been described in detail in connection with only a limited number of aspects, it should be readily understood that the invention is not limited to such disclosed aspects. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A resin comprising:
colloidal metal oxide particles;
a silane, wherein the silane comprises an amino silane or ureidosilane or both; and
a water dispersible polymer.

2. The resin of claim 1, wherein the colloidal metal oxides particles comprise at least one colloidal metal oxide particle selected from a group consisting of SiO₂, TiO₂, ZnO, and CeO₂.

3. The resin of claim 2, wherein the plurality of colloidal metal oxides particles comprises SiO_{2.}

4. The resin of claim 1, wherein the silane comprises an amino silane.

5. The resin of claim 4, wherein the amino silane comprises at least one amino silane selected from a group consisting of 3-aminopropyltriethoxysilane, 3-aminopropyltrimethoxysilane, 4-aminobutyltriethoxysilane, 4-amino-2-(dimethylethoxysilyl)propane, N-(2-aminoethyl)-3-aminoisobutyldimethylmethoxysilane, N-(2-aminoethyl)-3-aminoisobutylmethyldimethoxysilane, (aminoethylaminomethyl)phenethyltrimethoxysilane, N-(2-aminoethyl)-3-aminopropylmethyldimethoxysilane, N-(2-aminoethyl)-3-aminopropyltriethoxysilane, N-(2-aminoethyl)-3-aminopropyltrimethoxysilane, N-(6-aminohexyl)aminomethyltrimethoxysilane, N-(6-aminohexyl)aminopropyltrimethoxysilane, N-(2-aminoethyl)-11-aminoundecyltrimethoxysilane, 3-(m-aminophenoxy)propyltrimethoxysilane, m-aminophenyltrimethoxysilane, p-aminophenyltrimethoxysilane, aminophenyltrimethoxysilane, N-3-[(amino(polypropylenoxy)]aminopropyltrimethoxysilane, 3-aminopropyldiisopropylethoxysilane, 3-aminopropylmethylbis(trimethylsiloxy)silane, 3-aminopropyldimethylethoxysilane, 3-aminopropylmethyldiethoxysilane, aminopropylsilanetriol, 3-aminopropyltrimethylsilane, 3-aminopropyltris(methoxyethoxyethoxy)silane, 3-aminopropyltris(trimethylsiloxy)silane, and 11-aminoundecyltriethoxysilane.

6. The resin of claim 5, wherein the amino silane comprises 3-aminopropyltriethoxysilane.

7. The resin of claim 1, wherein the silane comprises an ureidosilane.

8. The resin of claim 7, wherein the ureidosilane comprise at least one ureidosilane selected from a group consisting of ureidopropyltriethoxysilane and ureidopropyltrimethoxysilane.

9. The resin of claim 1, wherein the silane comprises a plurality of silanes.

10. The resin of claim 1, wherein the water dispersible polymer comprises at least one water dispersible polymer selected from a group consisting of epoxy latex, polyurethane latex, polyacyrlate latex, and silicone latex.

11. The resin of claim 10, wherein the water dispersible polymer comprises an epoxy latex

12. The resin of claim 1, wherein the water dispersible polymer comprises a plurality of water dispersible polymers.

13. A method of making a resin comprising:
i) providing an aqueous dispersion of colloidal metal oxide particle; and providing a silane comprising at least an amino silane or ureidosilane, wherein the silane at least partially functionalizes the colloidal metal oxide particles; and
(ii) providing a water dispersible polymer to the aqueous dispersion, wherein the at least partially functionalized colloidal metal oxide particles are at least partially incorporated within the water dispersible polymer to form the resin.

14. The method of claim 13, wherein the plurality of colloidal metal oxides particles comprises at least one colloidal metal oxide particle selected from a group consisting of SiO₂, TiO₂, ZnO, and CeO₂.

15. The method of claim 14, wherein the plurality of colloidal metal oxides particles comprises SiO₂.

16. The method of claim 13, wherein the silane comprises an amino silane.

17. The method of claim 16, wherein the amino silane comprises at least one amino silane selected from a group consisting of 3-aminopropyltriethoxysilane, 3-aminopropyltrimethoxysilane, 4-aminobutyltriethoxysilane, 4-amino-2-(dimethylethoxysilyl)propane, N-(2-aminoethyl)-3-aminoisobutyldimethylmethoxysilane, N-(2-aminoethyl)-3-aminoisobutylmethyldimethoxysilane, (aminoethylaminomethyl)phenethyltrimethoxysilane, N-(2-aminoethyl)-3-aminopropylmethyldimethoxysilane, N-(2-aminoethyl)-3-aminopropyltriethoxysilane, N-(2-aminoethyl)-3-aminopropyltrimethoxysilane, N-(6-aminohexyl)aminomethyltrimethoxysilane, N-(6-aminohexyl)aminopropyltrimethoxysilane, N-(2-aminoethyl)-11-aminoundecyltrimethoxysilane, 3-(m-aminophenoxy)propyltrimethoxysilane, m-aminophenyltrimethoxysilane, p-aminophenyltrimethoxysilane, aminophenyltrimethoxysilane, N-3-[(amino(polypropylenoxy)]aminopropyltrimethoxysilane, 3-aminopropyldiisopropylethoxysilane, 3-aminopropylmethylbis(trimethylsiloxy)silane, 3-aminopropyldimethylethoxysilane, 3-aminopropylmethyldiethoxysilane, aminopropylsilanetriol, 3-aminopropyltrimethylsilane, 3-aminopropyltris(methoxyethoxyethoxy)silane, 3-aminopropyltris(trimethylsiloxy)silane, and 11-aminoundecyltriethoxysilane.

18. The method of claim 17, wherein the amino silane comprises 3-aminopropyltriethoxysilane.

19. The method of claim 13, wherein the silane comprises an ureidosilane.

20. The method of claim 19, wherein the ureidosilane comprise at least one ureidosilane selected from a group consisting of ureidopropyltriethoxysilane and ureidopropyltrimethoxysilane.

21. The method of claim 13, wherein the silane comprises a plurality of silanes.

22. The method of claim 13, wherein the water dispersible polymer comprises at least one water dispersible polymer selected from a group consisting of epoxy latex, polyurethane latex, polyacyrlate latex, and silicone latex.

23. The method of claim 22, wherein the water dispersible polymer comprises epoxy latex.

24. The method of claim 13, wherein the water dispersible polymer comprises a plurality of water dispersible polymers.

25. The method of claim 13, wherein the colloidal metal oxide particles at least partially incorporated within the water dispersible polymer are homogeneously dispersed within the water dispersible polymer.

26. The method of claim 13, wherein the colloidal metal oxide particles at least partially incorporated within the water dispersible polymer are randomly dispersed within the water dispersible polymer.

27. A corrosion inhibitor comprising:
a) a conducting polymer or conducting oligomer with a conjugated structure that provides electric conductivity when doped and;
b) an anion, wherein the anion comprises at least one anion selected from a group consisting of phosphomolybdate anion, permanganate anion, dichromate anion, ferrate anion, molybdate anion, salicylate anion, ethylenediamine tetraacetic anion, and amino acid.

28. The corrosion inhibitor of claim 27, wherein the corrosion inhibitor comprises at least one conducting polymer selected from a group consisting of polyaniline, polypyrrole, polythiophene, and their derivatives.

29. The corrosion inhibitor of claim 27, wherein the conducting polymer comprises a plurality of conducting polymers.

30. The corrosion inhibitor of claim 27, wherein the corrosion inhibitor comprises at least one conducting oligomer.

31. The corrosion inhibitor of claim 27, wherein the anion comprises at least one anion selected from a group consisting of phosphomolybdate anion, permanganate anion, dichromate anion, ferrate anion, molybdate anion, salicylate anion, ethylenediamine tetraacetic anion, and amino acid anion.

32. The corrosion inhibitor of claim 27, wherein the anion comprises a plurality of anions.

33. A coating composition comprising:
a resin, wherein the resin comprises:
colloidal metal oxide particles;
a silane, wherein the silane comprises at least one amino silane or ureidosilane;
a water dispersible polymer; and
a corrosion inhibitor.

34. The coating composition of claim 33, wherein the colloidal metal oxides particles comprise at least one colloidal metal oxide particle selected from a group consisting of SiO₂, TiO₂, ZnO, and CeO₂.

35. The coating composition of claim 34, wherein the colloidal metal oxides particles comprise SiO₂.

36. The coating composition of claim 33, wherein the silane comprises an amino silane.

37. The coating composition of claim 36, wherein the amino silane comprises at least one amino silane selected from a group consisting of 3-aminopropyltriethoxysilane, 3-aminopropyltrimethoxysilane, 4-aminobutyltriethoxysilane, 4-amino-2-(dimethylethoxysilyl)propane, N-(2-aminoethyl)-3-aminoisobutyldimethylmethoxysilane, N-(2-aminoethyl)-3-aminoisobutylmethyldimethoxysilane, (aminoethylaminomethyl)phenethyltrimethoxysilane, N-(2-aminoethyl)-3-aminopropylmethyldimethoxysilane, N-(2-aminoethyl)-3-aminopropyltriethoxysilane, N-(2-aminoethyl)-3-aminopropyltrimethoxysilane, N-(6-aminohexyl)aminomethyltrimethoxysilane, N-(6-aminohexyl)aminopropyltrimethoxysilane, N-(2-aminoethyl)-11-aminoundecyltrimethoxysilane, 3-(m-aminophenoxy)propyltrimethoxysilane, m-aminophenyltrimethoxysilane, p-aminophenyltrimethoxysilane, aminophenyltrimethoxysilane, N-3-[(amino(polypropylenoxy)]aminopropyltrimethoxysilane, 3-aminopropyldiisopropylethoxysilane, 3-aminopropylmethylbis(trimethylsiloxy)silane, 3-aminopropyldimethylethoxysilane, 3-aminopropylmethyldiethoxysilane, aminopropylsilanetriol, 3-aminopropyltrimethylsilane, 3-aminopropyltris(methoxyethoxyethoxy)silane, 3-aminopropyltris(trimethylsiloxy)silane, and 11-aminoundecyltriethoxysilane.

38. The coating composition of claim 37, wherein the amino silane comprises 3-aminopropyltriethoxysilane.

39. The coating composition of claim 33, wherein the silane comprises an ureidosilane.

40. The coating composition of claim 39, wherein the ureidosilane comprise at least one ureidosilane selected from a group consisting of ureidopropyltriethoxysilane and ureidopropyltrimethoxysilane.

41. The coating composition of claim 33, wherein the silane comprises a plurality of silanes.

42. The coating composition of claim 33, wherein the water dispersible polymer comprises at least one water dispersible polymer selected from a group consisting of epoxy latex, polyurethane latex, polyacyrlate latex and silicone latex,

43. The coating composition of claim 42, wherein the water dispersible polymer comprises epoxy latex.

44. The coating composition of claim 33, wherein the water dispersible polymer comprises a plurality of water dispersible polymers.

45. The coating composition of claim 33, wherein the corrosion inhibitor comprises:
a) a conducting polymer or conducting oligomer with a conjugated structure that provides electric conductivity when doped and;
b) an anion, wherein the anion comprises at least one anion selected from a group consisting of phosphomolybdate anion, permanganate anion, dichromate anion, ferrate anion, molybdate anion, salicylate anion, ethylenediamine tetraacetic anion, and amino acid.

46. The coating composition of claim 45, wherein the conducting polymer comprises at least one conducting polymer selected from a group consisting of polyaniline, polypyrrole, polythiophene, and their derivatives.

47. The coating composition of claim 46, wherein the anion comprises at least one anion selected from a group consisting of phosphomolybdate anion, permanganate anion, dichromate anion, ferrate anion, molybdate anion, salicylate anion, ethylenediamine tetraacetic anion, and amino acid.

48. The coating composition of claim 45, wherein the corrosion inhibitor comprises a conducting oligomer.

49. The coating composition of claim 33, wherein the corrosion inhibitor is at least partially incorporated within the resin.

50. A method of treating a substrate comprising:
applying a coating composition to a substrate, wherein the coating composition comprises:
a resin, wherein the resin comprises
colloidal metal oxide particles,
a silane, wherein the silane comprises at least one amino silane or ureidosilane;
a water dispersible polymer; and
a corrosion inhibitor.

51. The method of claim 50, wherein the colloidal metal oxides particles comprise at least one colloidal metal oxide particle selected from a group consisting of SiO₂, TiO₂, ZnO, and CeO₂.

52. The method of claim 51, wherein the colloidal metal oxides particles comprise SiO₂.

53. The method of claim 50, wherein the silane comprises an amino silane.

54. The method of claim 53, wherein the amino silane comprises at least one amino silane selected from a group consisting of 3-aminopropyltriethoxysilane, 3-aminopropyltrimethoxysilane, 4-aminobutyltriethoxysilane, 4-amino-2-(dimethylethoxysilyl)propane, N-(2-aminoethyl)-3-aminoisobutyldimethylmethoxysilane, N-(2-aminoethyl)-3-aminoisobutylmethyldimethoxysilane, (aminoethylaminomethyl)phenethyltrimethoxysilane, N-(2-aminoethyl)-3-aminopropylmethyldimethoxysilane, N-(2-aminoethyl)-3-aminopropyltriethoxysilane, N-(2-aminoethyl)-3-aminopropyltrimethoxysilane, N-(6-aminohexyl)aminomethyltrimethoxysilane, N-(6-aminohexyl)aminopropyltrimethoxysilane, N-(2-aminoethyl)-11-aminoundecyltrimethoxysilane, 3-(m-aminophenoxy)propyltrimethoxysilane, m-aminophenyltrimethoxysilane, p-aminophenyltrimethoxysilane, aminophenyltrimethoxysilane, N-3-[(amino(polypropylenoxy)]aminopropyltrimethoxysilane, 3-aminopropyldiisopropylethoxysilane, 3-aminopropylmethylbis(trimethylsiloxy)silane, 3-aminopropyldimethylethoxysilane, 3-aminopropylmethyldiethoxysilane, aminopropylsilanetriol, 3-aminopropyltrimethylsilane, 3-aminopropyltris(methoxyethoxyethoxy)silane, 3-aminopropyltris(trimethylsiloxy)silane, and 11-aminoundecyltriethoxysilane.

55. The method of claim 54, wherein the amino silane comprises 3-aminopropyltriethoxysilane.

56. The method of claim 50, wherein the silane comprises an ureidosilane.

57. The method of claim 56, wherein the ureidosilane comprises at least one ureidosilane selected from a group consisting of ureidopropyltriethoxysilane and ureidopropyltrimethoxysilane.

58. The method of claim 50, wherein the silane comprises a plurality of silanes.

59. The method of claim 50, wherein the water dispersible polymer comprises at least one water dispersible polymer selected from a group consisting of epoxy latex, polyurethane latex, polyacyrlate latex, and silicone latex.

60. The method of claim 59, wherein the water dispersible polymer comprises epoxy latex.

61. The method of claim 50, wherein the corrosion inhibitor comprises:
a) a conducting polymer or conducting oligomer with a conjugated structure that provides electric conductivity when doped and;
b) an anion, wherein the anion comprises at least one anion selected from a group consisting of phosphomolybdate anion, permanganate anion, dichromate anion, ferrate anion, molybdate anion, salicylate anion, ethylenediamine tetraacetic anion, and amino acid.

62. The method of claim 61, wherein the corrosion inhibitor comprises at least one conducting polymer selected from a group consisting of polyaniline, polypyrrole, polythiophene, and their derivatives.

63. The method of claim 62, wherein the anion comprises at least one anion selected from a group consisting of phosphomolybdate anion, permanganate anion, dichromate anion, ferrate anion, molybdate anion, salicylate anion, ethylenediamine tetraacetic anion, and amino acid anion

64. The method of claim 50, wherein treating the substrate comprises treating at least one substrate selected from a group consisting of metal, wood, plastic, concrete, and combinations thereof.

65. The method of claim 64, wherein the substrate comprises a metal substrate.

66. The method of claim 50, wherein treating the substrate combines a pre-treatment and priming step into a single step.

67. A method of making a coating composition comprising a resin and a corrosion inhibitor, the method comprising:
i) providing an aqueous dispersion of colloidal metal oxide particles and providing a silane, wherein the silane comprises at least an amino silane or ureidosilane; and wherein the silane at least partially functionalizes the colloidal metal oxide particles;
ii) providing a water dispersible polymer to the aqueous dispersion, wherein the at least partially functionalized colloidal metal oxide particles are at least partially incorporated within the water dispersible polymer;
iii) providing a corrosion inhibitor to the aqueous dispersion.

68. The method of claim 67, wherein the plurality of colloidal metal oxides particles comprises at least one colloidal metal oxide particle selected from a group consisting of SiO₂, TiO₂, ZnO, and CeO₂.

69. The method of claim 68, wherein the plurality of colloidal metal oxides particles comprises SiO₂.

70. The method of claim 67, wherein the silane comprises an amino silane.

71. The method of claim 70, wherein the amino silane comprises at least one amino silane selected from a group consisting of 3-aminopropyltriethoxysilane, 3-aminopropyltrimethoxysilane, 4-aminobutyltriethoxysilane, 4-amino-2-(dimethylethoxysilyl)propane, N-(2-aminoethyl)-3-aminoisobutyldimethylmethoxysilane, N-(2-aminoethyl)-3-aminoisobutylmethyldimethoxysilane, (aminoethylaminomethyl)phenethyltrimethoxysilane, N-(2-aminoethyl)-3-aminopropylmethyldimethoxysilane, N-(2-aminoethyl)-3-aminopropyltriethoxysilane, N-(2-aminoethyl)-3-aminopropyltrimethoxysilane, N-(6-aminohexyl)aminomethyltrimethoxysilane, N-(6-aminohexyl)aminopropyltrimethoxysilane, N-(2-aminoethyl)-11-aminoundecyltrimethoxysilane, 3-(m-aminophenoxy)propyltrimethoxysilane, m-aminophenyltrimethoxysilane, p-aminophenyltrimethoxysilane, aminophenyltrimethoxysilane, N-3-[(amino(polypropylenoxy)]aminopropyltrimethoxysilane, 3-aminopropyldiisopropylethoxysilane, 3-aminopropylmethylbis(trimethylsiloxy)silane, 3-aminopropyldimethylethoxysilane, 3-aminopropylmethyldiethoxysilane, aminopropylsilanetriol, 3-aminopropyltrimethylsilane, 3-aminopropyltris(methoxyethoxyethoxy)silane, 3-aminopropyltris(trimethylsiloxy)silane, and 11-aminoundecyltriethoxysilane; and

72. The method of claim 71, wherein the amino silane comprises 3-aminopropyltriethoxysilane.

73. The method of claim 67, wherein the silane comprises an ureidosilane.

74. The method of claim 73, wherein the ureidosilane comprises at least one ureidosilane selected from a group consisting of ureidopropyltriethoxysilane and ureidopropyltrimethoxysilane.

75. The resin of claim 67, wherein the silane comprises a plurality of silanes.

76. The method of claim 67, wherein the water dispersible polymer comprises at least one water dispersible polymer selected from a group consisting of epoxy latex, polyurethane latex, polyacyrlate latex, and silicone latex.

77. The method of claim 76, wherein the water dispersible polymer comprises epoxy latex.

78. The method of claim 67 wherein the water dispersible polymer comprises a plurality of water dispersible polymers.

79. The method of claim 67, wherein the corrosion inhibitor comprises at least one conducting polymer selected from a group consisting of polyaniline, polypyrrole, polythiophene, and their derivatives.

80. The method of claim 79, wherein the conducting polymer comprises a plurality of conducting polymers.

81. The method of claim 67, wherein the corrosion inhibitor comprises at least one conducting oligomer.

82. The method of claim 67, wherein the corrosion inhibitor comprises at least one anion selected from a group consisting of phosphomolybdate anion, permanganate anion, dichromate anion, ferrate anion, molybdate anion, salicylate anion, ethylenediamine tetraacetic anion, and amino acid.

83. The method of claim 82, wherein the anion comprises a plurality of anions.

84. The method of claim 67, wherein the corrosion inhibitor is incorporated within the resin.

85. A coating composition comprising:
a resin, wherein the resin comprises:
a plurality of colloidal metal oxide particles; wherein the plurality of colloidal metal oxides particles comprises at least one colloidal metal oxide particle selected from a group consisting of SiO₂, TiO₂, ZnO, and CeO₂;
a silane, wherein the silane comprises at least one amino silane or ureidosilane;
a water dispersible polymer; and
a corrosion inhibitor at least partially within the resin, wherein the corrosion inhibitor comprises:
a conducting polymer with a conjugated structure that provides electric conductivity when doped; and
an anion, wherein the anion comprises at least one anion selected from a group consisting of phosphomolybdate anion, permanganate anion, dichromate anion, ferrate anion, molybdate anion, salicylate anion, ethylenediamine tetraacetic anion, and amino acid anion.
